(19) United States
(12) Patent Application Publication
(10) Pub. No.: US 2005/0087171 A1
(43) Pub. Date: Apr. 28, 2005

(54) Low restriction engine brake and methods

(76) Inventor: Cory Lown, Bend, OR (US)

Correspondence Address: GLENN C. BROWN, PC, 777 NW WALL STREET, SUITE 308, BEND, OR, 97701, US

(21) Appl. No.: 10/976,205

(22) Filed: Oct. 26, 2004

Related U.S. Application Data
(63) Continuation of application No. 10/264,340, filed on Oct. 2, 2002.

(51) Int. Cl. F02D 9/06

(52) U.S. Cl. 123/323

(57) ABSTRACT

A vehicle engine brake has a body in which an internal passageway is defined and a valve member movably positioned within the passageway to selectively restrict flow through the passageway. The valve member is movable between at least first and second positions. In the first position, the valve member blocks a substantial portion of the internal passageway, thereby restricting exhaust gas flow through the engine brake in a flow direction. In the second position, the valve member allows flow through the passageway and past the valve member without substantial restriction.

### FIELD

This invention relates to an engine brake, and more specifically to an engine brake for motor vehicles.

### BACKGROUND

Engine brakes for vehicles with internal combustion engines are known. One type of engine brake is a device that restricts the flow of exhaust gas exiting from the engine through the exhaust system. By restricting the exhaust gas, the exhaust manifold pressure increases. The increased exhaust manifold pressure may be used to oppose the motion of the engine pistons, thereby slowing the engine and the vehicle. Selectively restricting the flow of exhaust gas from the engine is thus said to brake the vehicle.

Typical engine brakes are devices in which a butterfly valve member within the exhaust gas passageway is selectively moved to either (1) an open position (i.e., posing a minimal restriction) or (2) a “closed” or braking position (i.e., posing a significant restriction to exhaust flow and thus braking the engine). Such valve members are typically solid or substantially solid elements having a cross sectional area and a thickness. Even when the valve is moved to a fully open position, i.e., when no engine braking is desired, at least the thickness of the valve member still faces the incoming exhaust flow and poses a secondary restriction to this flow. Such a secondary restriction reduces the overall efficiency of the engine, since the engine must be operated to overcome at least the secondary restriction at all times.

In many aftermarket engine brake applications, installation requires removing a component of the exhaust system and substituting a customized component. If a used component must be unbolted, removal is often difficult because heat produced during vehicle operation causes bolts in exhaust system components to cease. It is often difficult and sometimes impossible to remove, e.g., an elbow, in an exhaust system, thereby necessitating replacement of additional parts to repair those destroyed during installation. Also, the available space for removing existing parts is often limited.

In addition, many aftermarket engine brake designs rely upon a different engine brake model to fit each different application. Maintaining an inventory of these different models to serve a wide customer base is very expensive and time consuming.

In one class of vehicles for which aftermarket engine brakes are popular, it is also common to increase the size of exhaust tubing (e.g., to 4 inch or even 5 inch inside diameter tubing) to increase overall engine performance. Even if installation of a typical engine brake for these vehicles is possible, it may have the smallest open cross-sectional area within the system (even when open), and thus represent the limiting restriction.

It would be desirable to provide an engine brake having an open or inactive mode in which little or no restriction is posed to exhaust gas flow. It would also be desirable to provide an engine brake that was simple to install and flexible in design to permit a single model or a few models to serve many different applications.

### SUMMARY

Described below are an engine brake, engine brake system and methods that overcome problems with prior art engine brakes.

In one implementation, a vehicle engine brake has an engine brake body and a valve member. In the engine brake body, a first end opening, an opposite second end opening and an internal passageway connecting the first and second end openings are defined. The valve member is mounted within the internal passageway between the first and second end openings. The valve member is selectively movable between at least first and second positions. In the first position, the valve member blocks a substantial portion of the internal passageway, thereby restricting flow through the engine brake in a flow direction. In the second position, the valve member allows flow through the passageway and past the valve member without substantial restriction.

In another implementation, a vehicle engine brake includes an engine brake body in which an internal through passageway is defined for receiving and conveying engine exhaust, and a valve member pivotally mounted within the passageway and having a central opening. The valve member is pivoted to align the opening with the passageway when the engine brake is inactive, thereby allowing exhaust to flow through the passageway without encountering any restriction from the valve member in a central area of the passageway.

In another implementation, a vehicle engine brake includes an engine brake body in which an internal through passageway is defined for receiving and conveying engine exhaust and a ball valve member having an axial bore. The valve member is movable within the engine brake body to selectively align the axial bore with the internal passage.

The bore of the ball valve may have a cross sectional area substantially equal to the cross sectional area of the internal passageway. The engine brake body may include a first portion coupled to a second portion with the body defining a generally spherical, internal recess sized to receive the ball valve member. The ball valve member may be pivotable within the engine brake body about an axis extending approximately perpendicular to a flow direction defined by the passageway. The ball valve member may have at least one pivot that protrudes through an opening in the body of the engine brake.

The engine brake may include an actuator having a body that is stationary relative to the engine brake body and a movable actuator rod with an end for connection to a pivot of the ball valve member. The actuator can be actuated to move the rod and in turn cause the ball valve member to rotate within the engine brake body to change the alignment of the axial bore relative to the passageway. The engine brake may include a mounting plate having a first end attached to the engine brake body and an opposite second end to which the actuator body is attached.

The actuator may be an electrical actuator, and may be controllable to position the ball valve member relative to the passageway in at least three different positions. The actuator may be controllable along at least a portion of its range of motion to allow a position of the ball valve member relative to the engine brake to be continuously varied.

The engine brake body may include mounting flanges that define openings at the end of the ends of the passageway.

According to a method of installing the engine brake in a vehicle with an existing stock exhaust system and a separate throttle control system, an engine brake with an internal through passageway and a ball valve member movable within the passageway to at least partially block the passageway is provided, a length of the stock exhaust passageway (typically a pipe) is removed, the ends of the engine brake are secured to the remaining ends of the passageway such that the exhaust system pathway through the engine brake is established, and the engine brake is electrically connected to the vehicle electrical system.

The new engine brake provides for higher performance, specifically by way of reducing the exhaust gas temperature, which results from decreasing the amount of restriction posed by the engine brake in the open or inactive mode. Other benefits include less wear, easier installation and more flexibility in fitting different applications. These and other advantages will be apparent upon a review of the following drawings and detailed description.

### BRIEF DESCRIPTION OF THE DRAWINGS

FIG. 1 is an exploded perspective view of an engine brake system that shows an engine brake with a ball valve, an actuator for the engine brake and an actuator mounting plate.

FIG. 2 is a perspective view of the engine brake in a partially assembled condition.

FIGS. 3 and 4 are additional perspective views of the assembled engine brake, actuator and actuator mounting plate.

FIG. 5 is a perspective view of one of the portions of the engine brake body.

FIG. 6 is a perspective view of an adapter flange used to connect the engine brake assembly to an end of the vehicle exhaust passageway.

FIGS. 7 and 8 are additional perspective views showing the mounting of the adapter flange to the engine brake assembly.

FIG. 9 is a schematic view of an electrical circuit for the engine brake system.

FIG. 10 is a perspective view of a prior art engine brake having a substantially solid valve member.

### DETAILED DESCRIPTION

FIG. 10 shows a perspective view of a prior art engine brake apparatus 100 with an engine brake body 200 having a bore defined therethrough in which a rotatable valve member 220 can be pivoted to block an incoming flow, thereby restricting the exhaust gas flow and braking the engine. As can be seen from FIG. 10, with a solid or “closed” valve member such as the element 220, the element 220 poses at least some secondary restriction to oncoming flow even when the engine brake is inactive as shown in FIG. 10. The circumferential surface of the valve member 220 facing the incoming air stream poses a substantial restriction or blockage, and thus increases the minimal pressure that the exhaust flow must exceed to pass through the engine brake apparatus. The increased minimal pressure leads to higher exhaust gas temperatures, which detract from performance.

Described below are implementations of an engine brake and an engine brake system in which any secondary restriction posed by the valve member is greatly reduced when compared to prior art devices of the type shown in FIG. 6.

### Overview

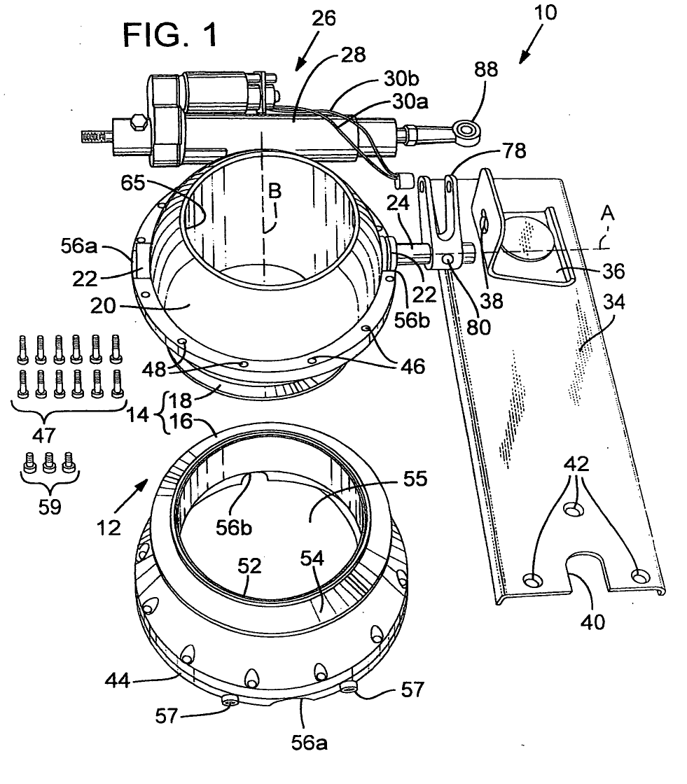

Referring to FIG. 1, an engine brake system 10 according to one implementation includes an engine brake assembly 12, an engine brake actuator 26 for coupling to the engine brake assembly 12 and an actuator mounting plate 34. The engine brake assembly 12 includes an engine brake body 14 having a first body portion 16 and a second body portion 18, which are shown disassembled in FIG. 1. The second body portion 18 is shown with a pivotable or rotatable ball valve member 20 positioned within the second body portion 18 and adjacent its inner surface.

The ball valve member 20 has an axis of rotation A that passes through external ball valve pivots 22. A ball valve rod 24 extends from one of the ball valve pivots 22 in the direction of the axis A.

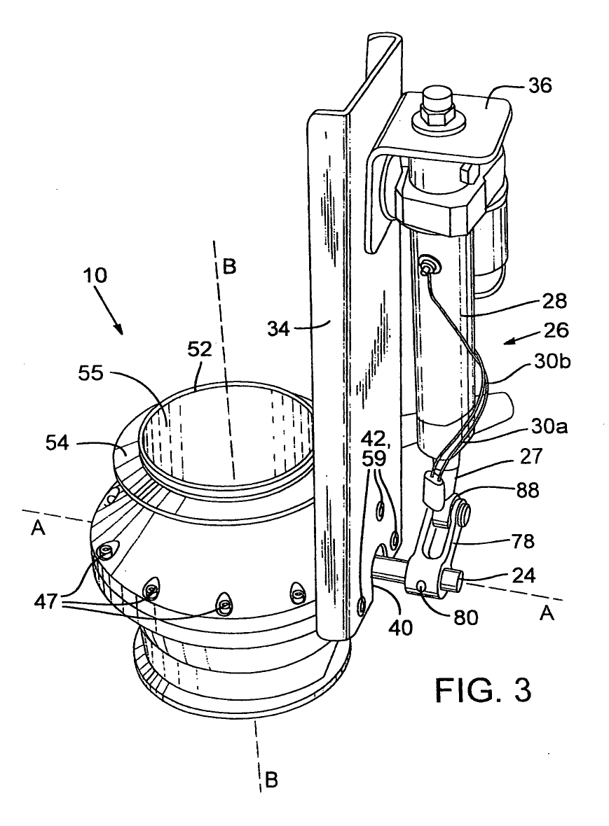

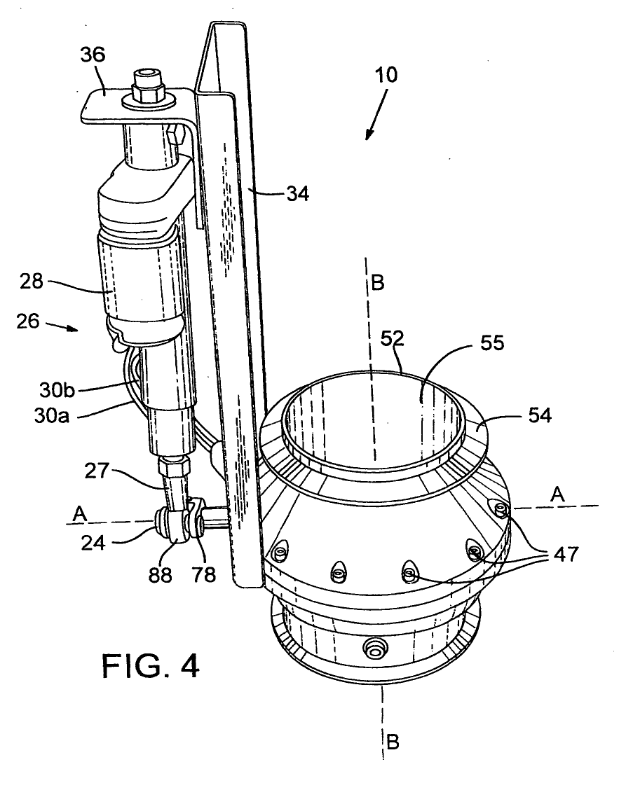

The actuator 26 has an actuator body 28 that remains stationary (i.e., fixed relative to the engine brake body 14) and an actuator rod 27 that extends or retracts relative to the actuator body 28 when the actuator is operated. The actuator rod has an actuator rod end 88 that is connected to a link 78 on the ball valve rod 24 to couple the ball valve member 20 and the actuator 26 together (see, e.g., FIGS. 3 and 4).

### Engine Brake Assembly

Referring to FIGS. 1-4, the engine brake assembly 12 has a generally cylindrical middle portion with a protruding rib and opposing end openings that define an internal through passageway. The rib is formed by the junction of a first mating flange 44 of the first body portion 16 and a second mating flange 46 of the second body portion 18. The first mating flange 44 has first mating flange apertures 48 and the second mating flange 46 has second mating flange apertures 50. The first body portion 16 may be joined to the second body portion 18 by threaded fasteners, such as bolts 47, that engage the mating flange apertures 48, 50.

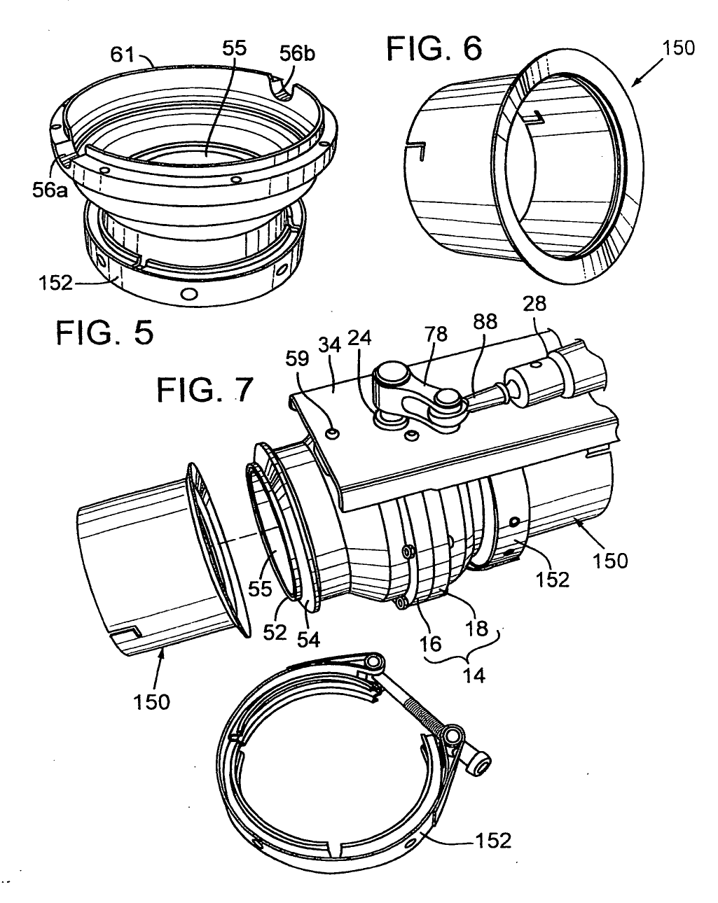

The first body portion 16 has a first lip 52 extending from a first mounting flange 54. The first lip 52 defines a first end opening 55. The first body portion 16 also includes bosses 57 that receive fasteners 59 to support the mounting plate 34 (FIGS. 3 and 4). As best shown in FIG. 5, one of the body portions 16, 18, in this case the first body portion 16, can include a upwardly projecting flange 61 to help seal the body portions together when they are assembled.

The second body portion 18 has a second lip (not shown) similar to the first lip 52 that defines a second end opening 63. First ball valve pivot supports 56a are defined at a same side of each of the first mating flange 44 and the second mating flange 46, forming an enclosed pivot support when these flanges are assembled together. Specifically, the first ball valve pivot support 56a on the second body portion 18 is an extension with an aperture for the rod 24, the extension fitting within the opening of the first ball valve pivot support 56a on the first body portion 16 to form the enclosed pivot support.

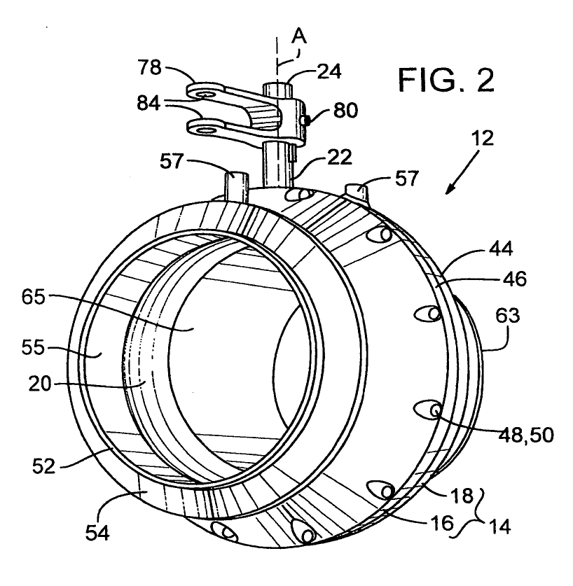

Second ball valve pivot supports 56b are defined at a side of each of the first and second mating flanges 44,46 opposite the first ball valve pivot supports. As shown in FIG. 2, the second ball valve pivot supports form a pivot support with an opening through which the ball valve rod 24 extends when the first and second mating flanges 44,46 are assembled together.

As best shown in FIG. 1, the ball valve member 20 is essentially a solid sphere having an axial bore 64, thereby resulting in a generally spherical outer side surface and opposed planar end surfaces. A central axis B of the bore 65 is substantially perpendicular to the axis A about which the ball valve member 20 can pivot relative to the engine brake body 14.

In a working implementation, the fit between the ball valve member 20 and the engine brake body 14, both of which are machined from a suitable material such as steel, is sufficiently close to eliminate the need for any seal, but still allow rotation of the ball valve member 20 relative to the engine brake body 14. A seal between the ball valve member 20 and the engine brake body 14 may be desirable, e.g., in other applications operating at higher pressures or in an assembly manufactured to lower tolerances.

The link 78, which may be forked as shown, is secured at a desired position on the ball valve rod with a set screw 80. As shown, the link 78 has an aperture 84, and the actuator rod end 88 is shaped to fit between the tines of the fork, with a pin or bolt securing the assembly together to establish a pivotable connection.

### Actuator and Electrical Circuit

Referring to FIGS. 3 and 4, the engine brake system 10 is shown in an assembled condition. The actuator 26 is supported by the mounting plate 34. Specifically, the mounting plate 34 has a first end at which a bracket 36 is attached by fasteners. The bracket 36 has an aperture 38 through which one end of the actuator 26 extends and is secured against movement. As shown in FIGS. 1 and 3, the opposite end of the mounting plate 34 has a slot 40 and mounting apertures 42 defined therein. The mounting plate 34 is attached to the first body portion 16 with threaded fasteners 59 secured to the bosses 57. The slot 40 is sized to provide clearance between the bracket 36 and the pivoting ball valve rod 24. As shown in FIG. 7, a hole sized for the rod 24 may be used instead of the slot 40.

As shown in FIGS. 3 and 4, the actuator 26 has a pair of wires 30a, 30b via which power is received to energize the actuator 26 and extend or retract the actuator rod 27.

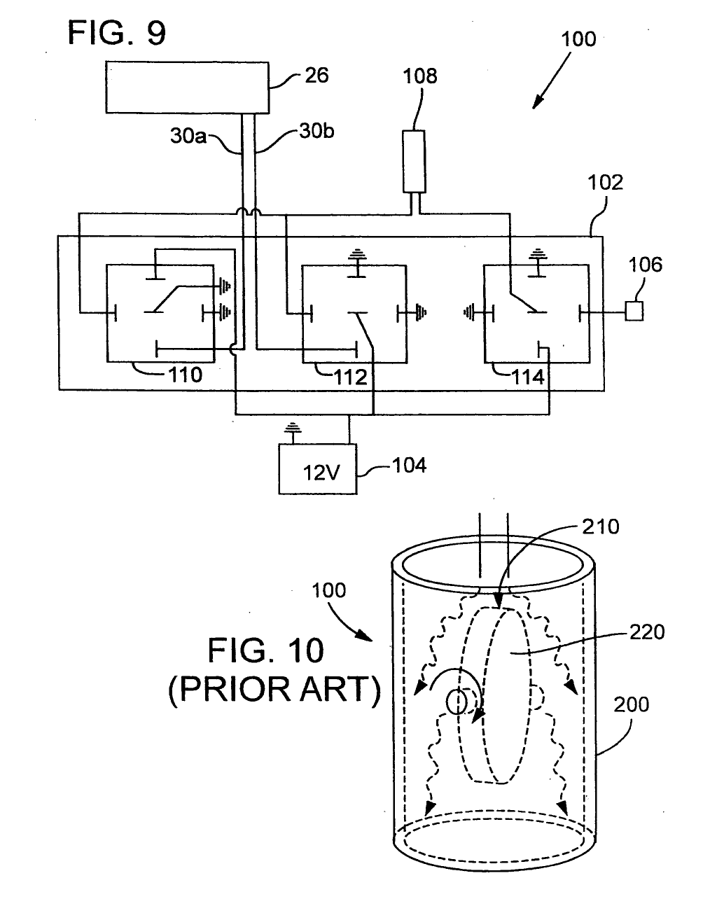

FIG. 9 is a schematic depiction of an electrical circuit 100 showing one implementation of an engine brake controller 102 and its connections to the actuator 26 and the vehicle electrical system. The aspects of the vehicle electrical system of interest here are a conventional 12-volt battery 104 that provides power to the circuit and a conventional throttle switch 106.

In the circuit, the throttle switch 106 is arranged in series with a second switch, such that both switches must be closed to provide power to the actuator 26. The second switch is a driver control switch 108 that allows the driver to request activation of the engine brake. Activation will occur if the current vehicle operating conditions are appropriate. In this implementation, the state of the throttle is the vehicle operating condition that is checked to determine if activation of the engine brake is appropriate. If the throttle is being applied, the throttle switch 106 is open and no activation of the engine brake will occur. If the throttle is neutral, the throttle switch 106 will be closed, and activation of the engine brake will occur if the switch 108 is closed. Also, if the engine brake is activated, and the throttle then changes from a neutral to an applied state, the engine brake will change from the closed or braking mode to the open mode.

Typically, the switch 108 is mounted within the vehicle interior near other operator controls. The switch 108 can be a push-pull switch, a toggle switch, a Browning switch, or any other suitable type of control. In implementations with variable control as described below, the switch 108 may have more than two positions and/or provide for variable control over at least a portion of the range of movement of the ball valve member 20.

The engine brake controller 102 according to one implementation is a network of three relays configured to allow for operation of the engine brake upon request of the driver if the vehicle operating conditions are appropriate (such as, e.g., the state of the throttle as described above). The engine brake controller is typically mounted in the dash area of the vehicle interior. With the controller 102, the ball valve member 20 can be moved between: (1) a fully open position (i.e., no restriction, the bore 65 of the ball valve member 20 is aligned with the openings 55,63); and (2) a braking position (i.e., the outer surface of the ball valve is rotated to block approximately 85-95% of the cross section of the internal passageway). In a specific implementation, the ball valve element is controlled to move so as to block about 90% of the cross section of the internal passageway in the braking position.

Each of the relays 110, 112, 114 is connected to receive power from the battery 104. The relay 110 is connected to supply power to the actuator 26 via the wire 30a, and the relay 112 is connected to supply power to the actuator 26 via the wire 30b. The actuator rod 27 moves in one direction in response to power supplied from the wire 30a, and in an opposite direction in response to power supplied from the wire 30b.

Each of the relays 110, 112, 114 is also connected to the switch 108. The relay 114 is also connected to the throttle switch 106. In this example, the throttle switch 106 is closed when the vehicle throttle is neutral (i.e., throttle not being applied, so engine is not accelerating). The engine brake system is configured to allow application of the engine brake upon request by the driver, unless the engine is accelerating, because restricting the exhaust passageway while the engine is accelerating is potentially damaging to the engine.

Therefore, if the throttle switch 106 is closed and the driver actuates the switch 108, application of the engine brake is authorized and the relay 114 will close to allow power to be supplied to the actuator 26 via one of the relays 110 and 112, both of which are normally open. For the purposes of this example, it is assumed that power is supplied to the actuator 26 via the wire 30a from the relay 110, and the actuator is energized to extend the rod 27 and rotate the ball valve member 20 from the open position to the braking position.

Thereafter, if the driver desires to remove or release the engine brake and actuates the switch 108 accordingly, power will be supplied to the actuator 26 via the wire 30b from the relay 112, provided the engine is not accelerating (i.e., throttle switch 106 remains closed). Power received via the wire 30b will energize the actuator to retract the rod 27 and move the ball valve member 20 from the braking position to the open position.

In one implementation, the relays are Bosch-type automotive relays. Of course, other similar components could be substituted, as would be known to those of ordinary skill in the art. It is also possible to implement the logic of the controller 102 using a circuit board and common circuit board components. A controller embodied in a circuit board may be simpler to package and cheaper to manufacture than the relay network.

Although the controller 102 as described above is configured for controlling movement between two positions of the ball valve member 20, other control schemes are also possible. For example, three or more discrete ball valve member positions are possible, e.g., open, low braking, high braking, etc. It is also be possible to use a rheostat or similar device in the controller 102 to provide for variable control over all or a portion of the range of motion of the ball valve member 20.

The actuator 26 may be a commercially available actuator, such as Model No. 512-09A4-02 from Warner Electric, or any other suitable electrical actuator. It would also be possible to configure the system to use pneumatic and other types of actuators.

### Installation

The engine brake assembly 12 is installed in line with the vehicle's existing exhaust system. Better results are achieved if the exhaust brake is installed as close as possible to and downstream of the engine itself or any turbocharger that is present.

It is easiest to install the engine brake assembly in an area where the existing exhaust pipe is approximately straight for at least about 12 inches. In a typical installation, a section of the existing straight exhaust passageway or “pipe” (about 7 inches in length) is removed, e.g., by cutting, which results in two exhaust pipe ends. The engine brake assembly 12 is installed by clamping its ends to the exhaust pipe ends.

In one implementation, an adapter flange 150 as shown in FIG. 6 is used to connect each end of the engine brake assembly 12 to the exhaust pipe ends. An upstream end of the engine brake assembly 12 is attached to an adapter flange 150 that fits over the upstream exhaust pipe end. Similarly, a downstream end of the engine brake is attached to an adapter flange 150 that fits inside of the downstream exhaust pipe end. This arrangement promotes better sealing at the joints.

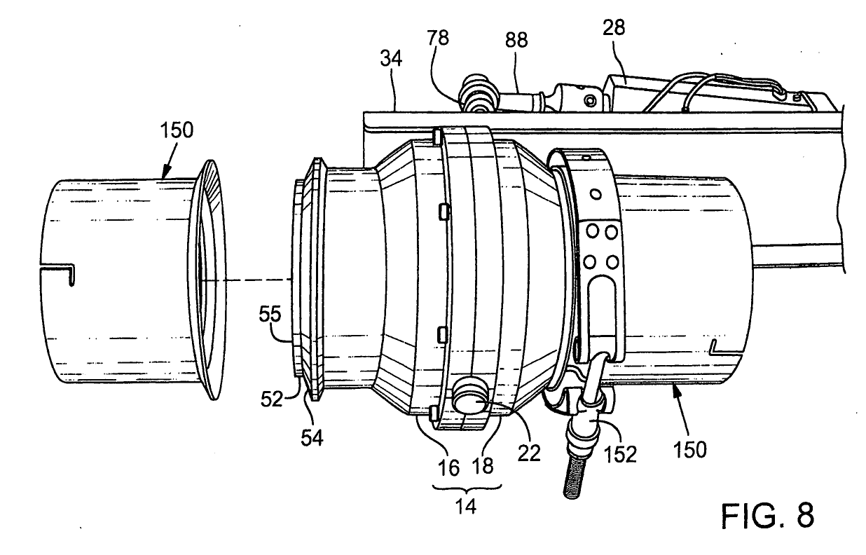

Each adapter flange 150 is secured to a respective end of the engine brake assembly 12 using a suitable clamp, such as the V-clamp 152 shown in FIGS. 7 and 8. The adapter flanges 150 are secured to the exhaust pipe ends using any suitable type of conventional exhaust pipe clamp.

The adapter flange 150 may be made of aluminized metal to allow it to deform slightly and promote better sealing when installed. Other components may be made of a steel or any other suitable material.

Having illustrated and described the principles of my invention with reference to several implementations, it should be apparent to those of ordinary skill in the art that the invention may be modified in arrangement and detail without departing from such principles.

1. A vehicle engine brake, comprising:
an engine brake body in which are defined a first end opening, an opposite second end opening and an internal passageway connecting the first and second end openings and defining a flow direction; and
a valve member mount ed within the passageway between the first and second end openings, the valve member being selectively moveable between at least first and second positions,
wherein the first position, the valve member blocks a substantial portion of the internal passageway, thereby restricting exhaust gas flow through the engine brake in the flow direction, and
wherein in the second position, the valve member allows flow through the passageway and past the valve member without substantial restriction.

2. A vehicle engine brake, comprising:
an engine brake body in which an internal through passageway is defined for receiving and conveying engine exhaust; and
a valve member pivotally mounted within the passageway and having a central opening,
wherein the valve member is pivoted to align the opening with the passageway when the engine brake is inactive, thereby allowing exhaust to flow through the passageway without encountering any central restriction from the valve member.

3. A vehicle engine brake, comprising:
an engine brake body in which an internal through passageway is defined for receiving and conveying engine exhaust; and
a ball valve member having an axial bore, the ball valve member being movable within the engine brake body to selectively align the axial bore with the internal passageway.

4. The vehicle engine brake of claim 3, wherein the bore of the ball valve has a cross sectional area at least as great as a smallest cross sectional area of the internal passageway.

5. The vehicle engine brake of claim 3, wherein the engine brake body includes a first portion coupled to a second position, the engine brake body defining a generally spherical internal recess sized to receive the ball valve member.

6. The vehicle engine brake of claim 3, wherein the ball valve member is pivotable within the engine brake body about an axis extending approximately perpendicular to a flow direction defined by the passageway, the ball valve member having at least one pivot that protrudes through an opening in the housing.

7. The vehicle engine brake of claim 6, further comprising an actuator having a stationary body and a movable actuator rod, wherein the rod has an end connectible to the pivot of the ball valve member, and wherein the actuator can be actuated to move the rod and in turn cause the ball valve member to rotate within the engine brake body thereby changing the alignment of the axial bore relative to the passageway.

8. The vehicle engine brake of claim 7, further comprising a mounting plate having a first end attached to the engine brake body and an opposite second end to which the actuator body is attached.

9. The vehicle engine brake of claim 7, wherein the actuator is an electrical actuator designed to receive electrical power from a vehicle electrical system.

10. The vehicle engine brake of claim 9, wherein the actuator is controllable to position the ball valve member relative to the passageway in at least three different positions.

11. The vehicle engine brake of claim 9, wherein the actuator has a range of motion, and wherein the actuator is controllable along at least a portion of the range of motion to allow a position of the ball valve member relative to the engine brake body to be continuously varied.

12. The vehicle engine brake of claim 3, wherein the engine brake body includes mounting flanges that define openings at the ends of the passageway, the mounting flanges allowing the engine brake to be retrofitted to an existing exhaust system passageway by removing a section of the existing passageway and securing remaining ends of the existing passageway to the mounting flanges of the engine brake.

13. The vehicle engine brake of claim 3, wherein a diameter of the axial bore in the ball valve member is sized for a four-inch diameter exhaust system.

14. The vehicle engine brake of claim 3, further comprising a pair of engine brake adjustment flanges for mounting the engine brake to stock exhaust system.

15. The vehicle engine brake of claim 3, wherein the ball valve member is configured to move relative to the engine brake body between at least a first braking position where the ball valve member blocks at least 85% of the cross-sectional area of the internal passageway and a second open position in which the ball valve member is aligned with the internal passageway.

16. The vehicle engine brake of claim 3, wherein the ball valve member is configured to move relative to the engine brake body between at least a first braking position where the ball valve member blocks at least 90% of the cross-sectional area of the internal passageway and a second open position in which the ball valve member is aligned with the internal passageway.

17. The vehicle engine brake of claim 3, wherein the ball valve member is configured to move relative to the engine brake body between at least a first braking position where the ball valve member blocks at least 95% of the cross-sectional area of the internal passageway and a second open position in which the ball valve member is aligned with the internal passageway.

18. The vehicle engine brake of claim 3, further comprising:
an actuator having a stationary body and a movable actuator rod, wherein the rod has an end connectible to a pivot of the ball valve member, and wherein the actuator can be actuated to move the rod and in turn cause the ball valve member to rotate within the engine brake body thereby changing the alignment of the axial bore relative to the passageway;
a drive control switch configured for use by the driver when desired to request activation of the engine brake; and
an engine brake controller connectible to the driver control switch, a battery of the vehicle and a throttle switch of the vehicle, the engine brake controller supplying power to the actuator when requested if the throttle switch state is appropriate.

19. The vehicle engine brake of claim 18, wherein the engine brake controller is a network that includes at least three relays.

20. A method of installing an engine brake in a vehicle with a stock exhaust system and a separate throttle control system, comprising:
providing an engine brake with an internal through passageway and a ball valve member movable within the passageway to a first position that at least partially blocks the passageway and a second position that causes no restrictions in the passageway;
removing a length of the stock exhaust system passageway of the vehicle, thereby providing two passageway ends;
securing the ends of the engine brake to the passageway ends such that an exhaust system pathway through the engine brake is established; and
electrically connecting engine brake controls to the vehicle electrical system.

21. The method of claim 20, wherein the act of securing the ends of the engine brake to the passageway ends includes securing the ends with clamps.

22. The method of claim 20, wherein the act of removing a section of the stock exhaust system includes cutting a portion of a stock exhaust passageway.

23. The method of claim 20, wherein a cross-sectional area of the engine brake is at least as great as a cross-sectional area of the stock exhaust system.

24. The method of claim 20, further comprising installing a driver's engine brake control in the cab of the vehicle.

25. The method of claim 20, wherein the engine brake is installed within the first five feet of exhaust passageway leading away from the engine.
